(19) United States
(12) Patent Application Publication
(10) Pub. No.: US 2011/0031043 A1
(43) Pub. Date: Feb. 10, 2011

(54) SELF-CHARGING ELECTRICAL CAR WITH WIND ENERGY RECOVERY SYSTEM

(76) Inventors: Sara Armani, Richmond Hill (CA); Antonio Alvi Armani, Toronto (CA); Fernando Armani, Richmond Hill (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/537,051

(22) Filed: Aug. 6, 2009

(51) Int. Cl. B60L 8/00; F03D 9/00; H02J 7/32; F03B 17/04

(52) U.S. Cl. 180/2.2; 290/55; 320/101; 74/DIG. 9

(57) ABSTRACT

An energy recovery system for a vehicle comprises an electrical generator provided within a housing. The housing is rotatable relative to the vehicle about a housing axis. The energy recovery system further comprises a wind turbine comprising a set of blades rotatable about a blade axis extending transverse to the housing axis. The wind turbine is supported by the housing and is rotatable with the housing. The electrical generator is coupled to the wind turbine and configured to convert the rotational energy of the set of blades into electrical energy.

### FIELD

The disclosure relates to an energy recovery system for a vehicle. More specifically, the disclosure relates to an energy recovery that converts wind energy into electrical energy.

### INTRODUCTION

The following is not an admission that anything discussed below is prior art or part of the common general knowledge of persons skilled in the art.

U.S. Pat. No. 3,876,925 discloses a mechanical combination in a wind turbine driven generator for the recharging of batteries utilized as the power source for various vehicles, and particularly an automotive electrically driven vehicle. In the mechanical combination, wind driven vanes of particular design are mounted to rotate about a vertical shaft disposed in or on the roof of the vehicle, said vanes being completely enclosed within a suitable housing of either rectangular or circular configuration. When of rectangular shape the housing has at least four air current receiving openings, one on each side, each of which do in turn serve as exhaust outlets depending on direction of predominant air pressure, and, when of circular configuration, the housing has but one air current receiving vent, with that vent revolving to face the direction of any wind current by the impetus of a wind vane on the top thereof. In either case the arrangement is such that the said wind driven vanes rotate while the vehicle is under way, or, if air currents are prevalent, even while the vehicle is not in motion, thus to drive a suitably mounted generator for more or less continuous recharge of the battery system. Said generator is mounted within the hub around which said vanes rotate, and comprises a stationary stator, and rotating rotor, the latter being wind driven by the rotating vanes.

U.S. Pat. No. 5,280,827 discloses an electric motor-driven vehicle which has a large wind turbine mounted at the rear of the vehicle that rotates about an axis perpendicular to the axis of the vehicle body. A long venturi tube extends along the upper portion of the vehicle above the passenger cab and directs air flow from the front of the vehicle and impinges it upon an upper portion of the turbine blades. A pair of elongated lower screw-type turbines are contained in separate lower venturi effect tubes extending along the lower side of the vehicle below the passenger cab. Air from the lower venturi effect tubes is impinged upon the large turbine in a direction and at a location to increase the force generated from the upper venturi tube. The turbines drive one or more electric power generators coupled to storage batteries for recharging the batteries.

U.S. Pat. No. 7,434,636 discloses a power system for an electric vehicle, the power system comprising at least one power generating device selected from a group consisting of a solar panel, a wind turbine capable of producing electrical power, an auxiliary generator driven by an internal combustion engine, and a generator for producing electrical power mechanically connected to, and driven by the rotational force of an axle of a vehicle. The power system being further comprised of a charging device, a battery control device, at least one battery, a motor control device, an electric drive motor electrically connected to the motor control device, and a driver interface connected to the motor control device. The electric drive motor may be used to generate power through regenerative braking. The wind turbine may be raised outside the body of a vehicle while the vehicle is not in motion. The solar panel may be disposed outside the vehicle while remaining electrically connected to the charging device.

### SUMMARY

The following summary is provided to introduce the reader to the more detailed discussion to follow. The introduction is not intended to limit or define the claims.

According to one aspect, an energy recovery system for a vehicle is provided. The energy recovery system comprises an electrical generator provided within a housing, the housing is rotatable relative to the vehicle about a housing axis. The energy recovery system further comprises a wind turbine comprising a set of blades rotatable about a blade axis extending transverse to the housing axis. The wind turbine is supported by the housing and is rotatable with the housing. The electrical generator is coupled to the wind turbine and configured to convert the rotational energy of the set of blades into electrical energy.

The energy recovery system may further comprise a wind vane mounted to at least one of the wind turbine and the housing.

The energy recovery system may further comprise one or more stops limiting the rotation of the housing.

The housing axis may be generally vertical, and the blade axis may be generally horizontal.

The energy recovery system may further comprise a second electrical generator provided within the housing and coupled to the wind turbine and configured to convert the rotational energy of the set of blades into electrical energy.

The wind turbine may further comprise a gear mounted around the set of blades and rotatable with the set of blades. The electrical generator may be coupled to the set of blades via the gear

The energy recovery system may further comprise at least one battery electrically coupled to the electrical generator. The battery may be non-rotatably mounted with respect to the vehicle.

The energy recovery system may further comprise an airflow chamber mountable to the exterior of the vehicle. The airflow chamber may comprise an air inlet positionable to receive an incoming stream of air, and an air outlet positionable to exhaust the stream of air. The wind turbine may be provided within the airflow chamber. The airflow chamber may have an inlet cross sectional area at the inlet, and a reduced cross-sectional area at a position downstream of the inlet.

The airflow chamber may be defined by a casing, which may be removably mounted to the vehicle. The casing may further define a storage chamber in which the housing is received. The airflow chamber may have a bottom wall, the casing may have a lower wall beneath and spaced from the bottom wall, and the storage chamber may be between the bottom wall and the lower wall. The housing may be mounted to the lower wall. The bottom wall may extend upwardly from the air inlet towards the air outlet.

The set of blades may comprise more than 3 blades, for example at least 9 blades spaced equally about the blade axis.

According to another aspect, an energy recovery system for a vehicle is provided. The energy recovery system comprises an airflow chamber mountable to an exterior of the vehicle. The airflow chamber comprises an air inlet positionable to receive an incoming stream of air, and an air outlet positionable to exhaust the stream of air. The airflow chamber has an inlet cross sectional area at the inlet, and a reduced cross-sectional area at a position downstream of the inlet. One or more wind turbines are provided in the airflow chamber. Each wind turbine comprises a set of blades rotatable about a blade axis. The energy recovery system further comprises one or more bases. Each base supports one or more of the wind turbines. Each base is rotatable with respect to the airflow chamber about a base axis extending transverse to the blade axis. The energy recovery system further comprises one or more electrical generators. Each electrical generator is coupled to one or more of the wind turbines, and is configured to convert the rotational energy of the set of blades of the one or more wind turbines into electrical energy.

The base axis of each base may be generally vertical, and the blade axis of each wind turbine may be generally horizontal. Each base may serve as a housing for one or more of the electrical generators. The one or more of the electrical generators may be rotatable with the base. Each base may comprise one or more stops limiting the rotation of the base.

The energy recovery system may further comprise one or more wind vanes. Each wind vane may be mounted to at least one of the wind turbines and one of the bases.

Each wind turbine may further comprise a gear mounted around the set of blades and rotatable with the set of blades, and the electrical generators are coupled to the sets of blades via the gears.

The energy recovery system may further comprise at least one battery coupled to the electrical generators. The battery may be non-rotatably mounted with respect to the vehicle.

The airflow chamber may be defined by a casing. The casing may be removably mountable to one of the roof of the vehicle and the underside of the cab of the vehicle. The casing may further define a storage chamber in which the electrical generators are received. The airflow chamber may have a bottom wall, the casing may have a lower wall beneath and spaced from the bottom wall, and the storage chamber may be between the bottom wall and the lower wall. Each base may be mounted to the lower wall. The bottom wall may extend upwardly from the air inlet towards the air outlet.

The set of blades may comprise more than 3 blades, for example the set of blades may comprise at least 9 blades spaced equally about the blade axis.

According to another aspect, an energy recovery system for a vehicle is provided. The energy recovery system comprises a wind turbine comprising a set of blades rotatable about a blade axis. A gear is mounted around the set of blades and is rotatable with the set of blades. A base supports the wind turbine. The base is rotatably mounted with respect to the vehicle about a base axis extending transverse to the blade axis. The energy recovery system further comprises an electrical generator coupled to the gear and configured to convert the rotational energy of the gear into electrical energy.

The wind turbine may have a blade diameter defined by a circumference of a radially outer edge of the blades when rotating about the blade axis. The gear may have a toothed outer surface having pitch diameter greater than blade diameter.

The gear may be annular and may define a central bore. A thickness of the gear may be about 10-50% of the pitch diameter.

The electrical generator may comprise a drive shaft with a pinion affixed to the drive shaft. The pinion may engage the gear.

The base may serve as a housing for the electrical generator. The electrical generator may be rotatable with the base. The energy recovery system may further comprise one or more stops limiting the rotation of the base. The base axis may be vertical, and the blade axis may be horizontal.

The energy recovery system may further comprise a wind vane mounted to at least one of the wind turbine and the base.

The energy recovery system may further comprise a second electrical generator coupled to the gear and configured to convert the rotational energy of the set of blades into electrical energy.

The energy recovery system may further comprise at least one battery coupled to the electrical generator. The battery may be non-rotatably mounted with respect to the vehicle.

The energy recovery system may further comprise an airflow chamber mountable to the exterior of the vehicle. The airflow chamber may comprise an inlet positionable to receive an incoming stream of air, and an air outlet positionable to exhaust the stream of air. The wind turbine may be provided within the airflow chamber.

The airflow chamber may be defined by a casing. The casing may further define a storage chamber for the electrical generator. The airflow chamber may have a bottom wall, and the storage chamber may be below the bottom wall. The casing may have a lower wall which is mountable to the vehicle, and the storage region may be between the bottom wall and the lower wall. The bottom wall may extend upwardly from the air inlet towards the air outlet.

The set of blades may comprise more than three blades, for example at least 9 blades spaced equally about the blade axis.

According to another aspect, an energy recovery system for a vehicle is provided. The energy recovery system comprises a casing mountable to an exterior of the vehicle. The casing defines a storage chamber and an airflow chamber. The airflow chamber comprises an air inlet positionable to receive an incoming stream of air, an air outlet positionable to exhaust the stream of air, and an axis extending therebetween. One or more wind turbines are provided in the airflow chamber. Each wind turbine comprises a set of blades rotatable about a blade axis. One or more electrical generators are provided in the storage chamber. Each electrical generator is coupled to one or more of the wind turbines and configured to convert the rotational energy of the set of blades into electrical energy. A wall separates the storage chamber from the airflow chamber. At least a portion of the wall extends towards the axis so that a cross-sectional area of the airflow chamber at a position downstream of the inlet is less than a cross-sectional area of the airflow chamber at the inlet.

The wall may be a bottom wall of the airflow chamber, and the bottom wall may extend upwardly from the inlet towards the outlet.

The casing may further comprise a lower wall beneath and spaced from the bottom wall. The lower wall and the bottom wall may define the storage chamber.

Each electrical generator may be provided in a housing, and each housing may support one or more of the wind turbines. Each housing may be mounted to the lower wall. Each housing may be rotatable about a housing axis extending transverse to the blade axis. The blade axis of each wind turbine may generally horizontal, and the housing axis of each housing may be generally vertical. Each housing may comprise one or more stops limiting the rotation thereof.

The energy recovery system may further comprise one or more wind vanes. Each wind vane may be mounted to one of the wind turbines.

Each wind turbine may further comprise a gear mounted around the set of blades and rotatable with the set of blades. The electrical generators may be coupled to the sets of blades via the gears.

The energy recovery system may further comprise at least one battery coupled to the electrical generators. The battery may be non-rotatably mounted with respect to the vehicle.

The casing may be removably mountable to one of the roof of the vehicle and the underside of the cab of the vehicle.

The set of blades may comprise more than 3 blades, for example at least 9 blades spaced equally about the blade axis.

### DRAWINGS

Reference is made in the description to the attached drawings, in which:

FIG. 1A is a front perspective view of a vehicle comprising an example of a first and a second energy recovery system;

FIG. 1B is a rear perspective view of the vehicle of FIG. 1A;

FIG. 2A is a perspective view of the first energy recovery system of FIG. 1, showing a top wall in an open configuration;

FIG. 2B is a perspective view of the second energy recovery system of FIG. 1, showing a top wall in an open configuration;

FIG. 3 is a perspective illustration of a wind turbine of the energy recovery system of FIG. 2;

FIG. 4 is a top plan view of the wind turbine of FIG. 3;

FIG. 5 is a partial cross section taken along line 5-5 in FIG. 4;

FIG. 6 is a partial cross section taken along line 6-6 in FIG. 4;

FIG. 7 is a partial cross section taken along line 7-7 in FIG. 2; and

FIG. 8 is a schematic illustration of the energy recovery system of FIG. 2, showing various angular positions of wind turbines.

### DESCRIPTION OF VARIOUS EMBODIMENTS

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

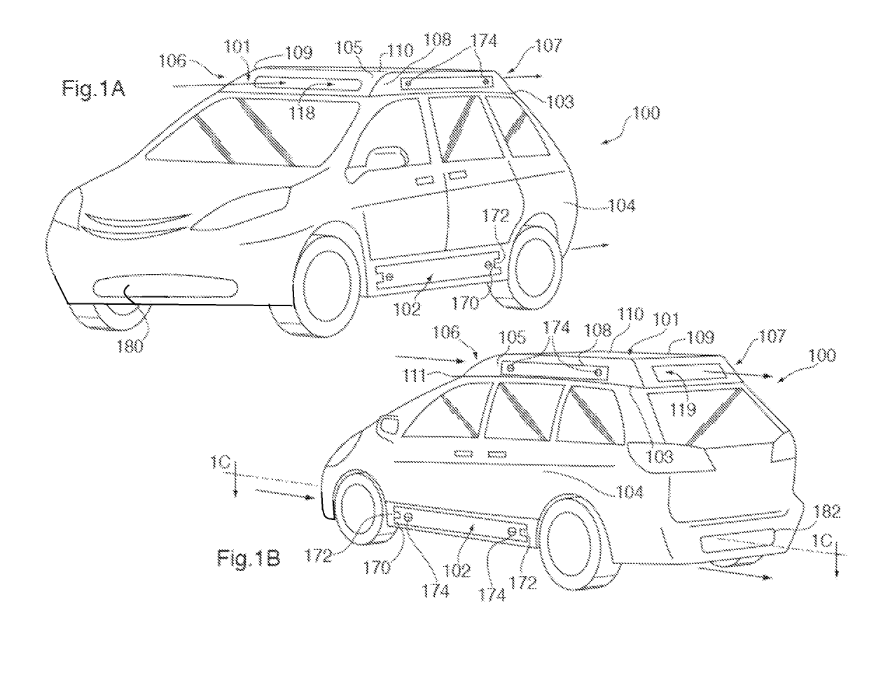

Referring to FIGS. 1A and 1B, a vehicle 100 is shown. As shown, the vehicle 100 is an automobile, and more particularly, a passenger car. In alternate examples, the vehicle may be a truck, an aircraft, a boat, a motorcycle, a bicycle, a scooter, a truck, a train, a carriage, a cart, a snowmobile, an amphibious vehicle, an all terrain vehicle, or any other type of suitable vehicle.

The vehicle 100 includes a first energy recovery system 101 and a second energy recovery system 102. Each energy recovery system 101, 102 captures kinetic energy from the movement of the air surrounding the vehicle 100 with respect to the vehicle 100. The movement of the air may be created due to the movement of the vehicle 100 through the surrounding air, and/or due to the movement of the air surrounding the vehicle 100 (i.e. ambient wind). The speed of the air passing through the first and second energy recovery systems 101, 102 is related to the vehicle's speed. If, for example, the vehicle 100 is a passenger car driving on a highway at 100 km/h, the air entering the first and second energy recovery systems 101, 102 will be traveling at approximately 100 km/h relative to the energy recovery systems 101, 102 (subject to atmospheric variations—i.e. headwind or tailwind). The relative wind speed of air engaging the energy recovery systems 101, 102 on a vehicle traveling at 100 km/h will be approximately 100 km/h even in the absence of ambient wind (i.e. on a calm day).

The first energy recovery system 101 is mounted to the roof 103 of the vehicle 100, and the second energy recovery system 102 is mounted under the cab 104 of the vehicle 100. In alternate examples, the vehicle 100 may include only one of the first energy recovery system 101 and the second energy recovery system 102. In further alternate examples, more than two energy recovery systems may be mounted to the vehicle 100. In further alternate examples, any energy recovery systems may be mounted elsewhere on the vehicle 100, for example on a door of the vehicle 100, or on a hood of the vehicle 100.

Vehicles adapted to use the second energy recovery system 102 may include a front air opening 180 and a rear exhaust opening 182 as shown in FIGS. 1A-1C. The front air opening 180 forms the entrance to an air passage way or conduit (not shown) that extends from the front of the vehicle 100 to the inlet 118 of the second energy recovery system 102, which is described in more detail below. The walls of the air passage way may be curved, angled or otherwise shaped to guide, direct and compress the air traveling through the conduit as it approaches the inlet 118. The front air opening 180 may have a larger area than the inlet 118 and may serve as a scoop or funnel for directing a relatively large volume of air toward the inlet 118.

Similarly, the rear exhaust opening 182 may be connected to the outlet 119 by an enclosed air passage way 183 so that air leaving the energy recovery system 102 via the outlet 119 is ducted and routed so that it exits the vehicle via the rear exhaust opening 182. The walls of the passageway 184 connecting the outlet 119 and the rear exhaust opening 182 may be curved, angled or otherwise shaped to achieve desired airflow characteristics.

Alternatively, the vehicle 100 may not include external openings such as the front air opening 180 and the rear exhaust opening 182. In the absence of openings 180, 182, air may flow beneath the vehicle and enter the inlet 118 and exit the outlet 119 without being ducted or routed.

In the example shown, the first energy recovery system 101 and the second energy recovery system 102 are similar and as such, only the first energy recovery system 101 will be described in detail.

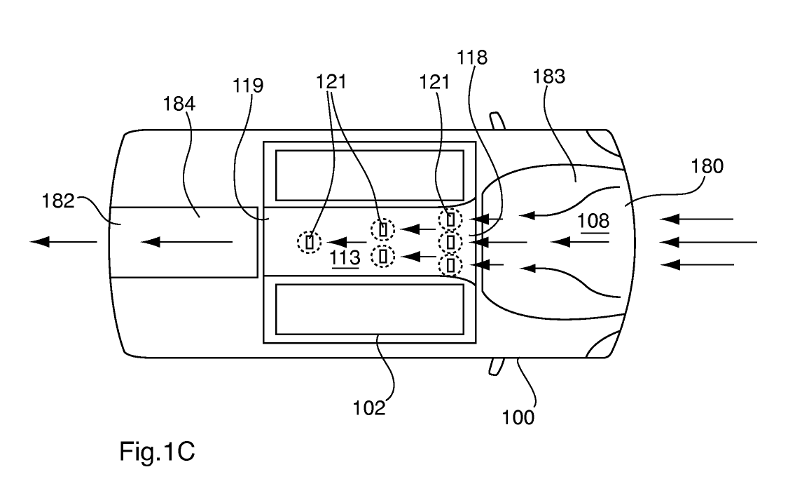

Referring to FIGS. 1A to 2B, in the example shown, the first energy recovery system 101 includes a casing 105, which is mountable to the exterior of the vehicle 100, for example the roof 103 of the vehicle 100. The casing 105 may be mountable to the vehicle 100 in any suitable fashion. For example, the casing 105 may include hooks which engage the doorframe of the automobile (not shown), in a similar fashion to a roof rack. In alternate examples, the casing may be integral with the vehicle. In alternate examples, the vehicle may comprise an integral mount, to which the energy recovery system 101 may be removably mounted. For example, the roof 103 may comprise an integral mount, and the energy recovery system 101 may be slidably and lockably received in the mount.

The energy recovery system 101 may be configured as a self-contained cartridge that can be installed or removed from the vehicle as a single unit. The casing 105 may serve as the housing or shell of the cartridge and may be equipped with a quick-disconnect fitting for providing electric communication between the energy recovery system 101 and other elements of the vehicle 100. Such a cartridge configuration may enable a user or service technician to easily “plug-in”, remove or swap the complete energy recover system for maintenance, replacement, inspection, transferring between vehicles or any other purpose.

The casing 105 has a front end 106, which faces the front of the vehicle 100, a rear end 107, which faces the rear of the vehicle 100. The casing 105 further includes first 108 and second 109 opposed side walls extending between the front end 106 and the rear end 107, and an upper wall 110 and a lower wall 111 extending between the front end and the rear end. A longitudinal axis 112 of the casing 105 extends between the front end 106 and the rear end 107.

In examples in which the energy recovery systems 101, 102 are removable they may be slidably received within corresponding regions of the vehicle 100. As shown, the casing 105 of the second energy recovery system 102 includes grooves or channels 170 formed on its front and back faces that slidingly receive corresponding projections or ribs 172 on the vehicle 100. The mating grooves 170 and ribs 172 may support the weight of the energy recovery system 102 and may be lubricated (or equipped with rollers or sliders) to serve as a bearing or bushing. Alternatively, or in addition to the support of the grooves 170 and ribs 172, the bottom of the casing of the energy recovery system may include additional bearings, rollers or sliders (not shown) for supporting the weight of the energy recovery system and allowing sideways movement thereof. In other examples, as shown by the first energy recovery system 101, the casing 105 may not include grooves and the vehicle may not include corresponding ribs. In these examples, the energy recovery system may be supported by bearings on the lower surface of the casing, or may simply rest against an exposed surface of the vehicle, with or without lubrication.

To secure removable energy recovery systems to the vehicle, each energy recovery system may include a locking or attachment system. In the examples shown, the locking system comprises rotatable pins 174 in the casing 105 that can be rotated from an unlocked position (in which they do not engage the vehicle) to a locked position (in which a latch or other locking feature engages a corresponding receptacle or other feature on the vehicle). Alternatively, the locking system may be any suitable locking mechanism, including clips, latches, magnets, keys and pins.

In some examples, the casing 105 may be openable. For example, as shown in FIG. 2, the upper wall 110 is pivotally mounted, so that the casing 105 can be opened. This may allow a user to access to contents of the casing 105, so that the contents may be replaced, repaired, or observed.

Referring still to FIG. 2, the casing 105 comprises an airflow chamber 113, which is defined by a plurality of sidewalls. Specifically, in the example shown, the airflow chamber 113 is defined by first 114 and second 115 opposed lateral walls, a top wall 116, and a bottom wall 117. Further, in the example shown, the top wall 116 is provided by the upper wall 110 of the casing 105. The first 114 and second 115 opposed lateral walls and the bottom wall 117 of the airflow chamber 113 are separate from the first 108 and second 109 opposed side walls and the lower wall 111 of the casing 105. That is, the first 114 and second 115 opposed lateral walls and the bottom wall 117 are interior to the casing 105.

In some examples, the bottom wall 117 may have a cross-sectional profile that resembles an inverted airfoil (i.e. a wing-like design in which the “lifting” force generated by the wing is directed toward the ground). As air flows over the bottom wall 117, its inverted airfoil or “reverse wing” configuration may generate a downward force which may help keep the vehicle in contact with the road or other surface at high speeds.

The airflow chamber 113 further comprises an air inlet 118 and an air outlet 119. The inlet 118 is positioned to receive an incoming stream of air, and the outlet 119 is positioned to exhaust the stream of air. A chamber longitudinal axis 120 extends between the inlet 118 and the outlet 119. In the example shown, the inlet 118 is at the front 106 of the casing 105, facing the front of the vehicle 100, and the outlet 119 is at the rear 107 of the casing 105, facing the rear of the vehicle 100, so that as the car is driven in a forward direction, air enters the inlet 118 and exits the outlet 119.

In the example shown, the airflow chamber 113 has a cross sectional area at the inlet 118, and a reduced cross sectional area at a position downstream from the inlet 118. That is, the cross sectional area of the airflow chamber 113 decreases from the inlet 118 towards the outlet 119. This reduction in cross sectional area serves to increase the velocity of the air passing through the airflow chamber 113. The ratio of the inlet area to the outlet area can be selected based on the a variety of operating conditions including, expected speed of the air entering the energy recovery system 101, the number, size and position of wind turbines 121 housed in the energy recovery system 101 and the amount of aerodynamic drag generated as the air is compressed and/or accelerated through the energy recovery system 101.

In the example shown, the cross sectional area decreases gradually along the entire length of the airflow chamber 113. In alternate examples, the cross sectional area may decrease along only a portion of the length of the airflow chamber 113. In the example shown, the first 114 and second 115 opposed lateral walls and the bottom wall 117 converge towards the chamber longitudinal axis 120 to achieve the reduction in cross sectional area. Specifically, the first 114 and second 115 opposed lateral walls extend inwardly from the air inlet 118 towards the air outlet 119, and the bottom wall 117 extends upwardly from the air inlet 118 towards the air outlet 119. In alternate examples, only one of the sidewalls, or any other combination of the sidewalls may converge towards the longitudinal axis 120.

Referring still to FIG. 2, the energy recovery system 100 further comprises one or more wind turbines 121. In the example shown, each wind turbine 121 is provided within the airflow chamber 113, and is configured to convert the kinetic energy of the air passing through the airflow chamber 113 into rotational energy.

In the example shown, the energy recovery system 100 comprises six wind turbines 121. However, in alternate examples, any suitable number of wind turbines 121 may be provided, for example only one wind turbine 121, or more than six wind turbines 121. In the example shown, each wind turbine is substantially identical. As such, only wind turbine 121a will be described in detail.

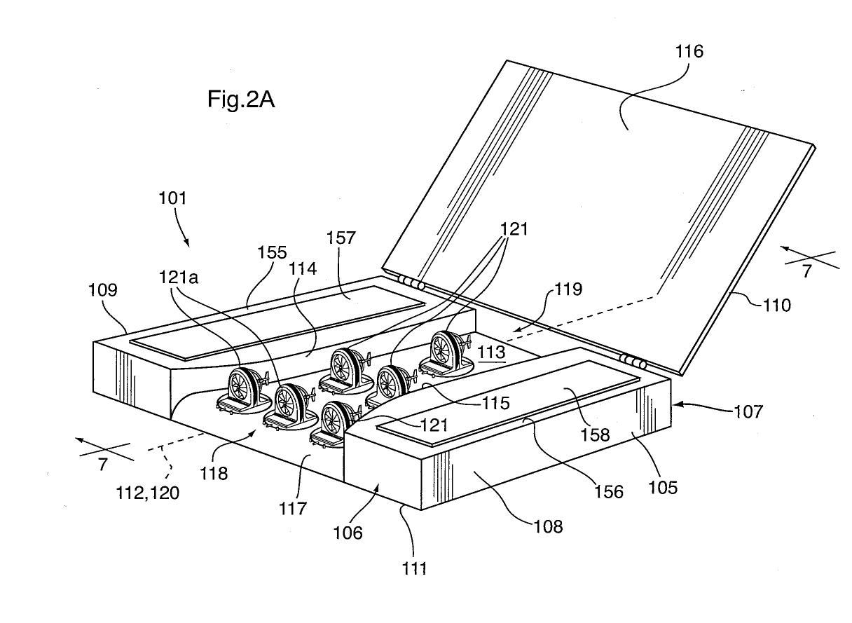

Referring to FIGS. 3 to 7, wind turbine 121a comprises a set of blades 122, which is rotatable about a blade axis 123. The set of blades 122 may be of any suitable configuration which rotates in response to air passing through the airflow chamber 113. For example, as shown, the set of blades 122 is positioned in a vertical plane, and the blade axis 123 is generally horizontal. In alternate examples, the set of blades 122 may be positioned in a plane that is at an angle with respect to the vertical plane, and the blade axis 123 may be at an angle with respect to the horizontal.

In the example shown, the set of blades 122 comprises 9 blades 124. In alternate examples, another number of blades 124 may be provided. For example, the number of blades may be between 3 and about 18 blades, between 3 and about 9 blades, or more than 18 blades.

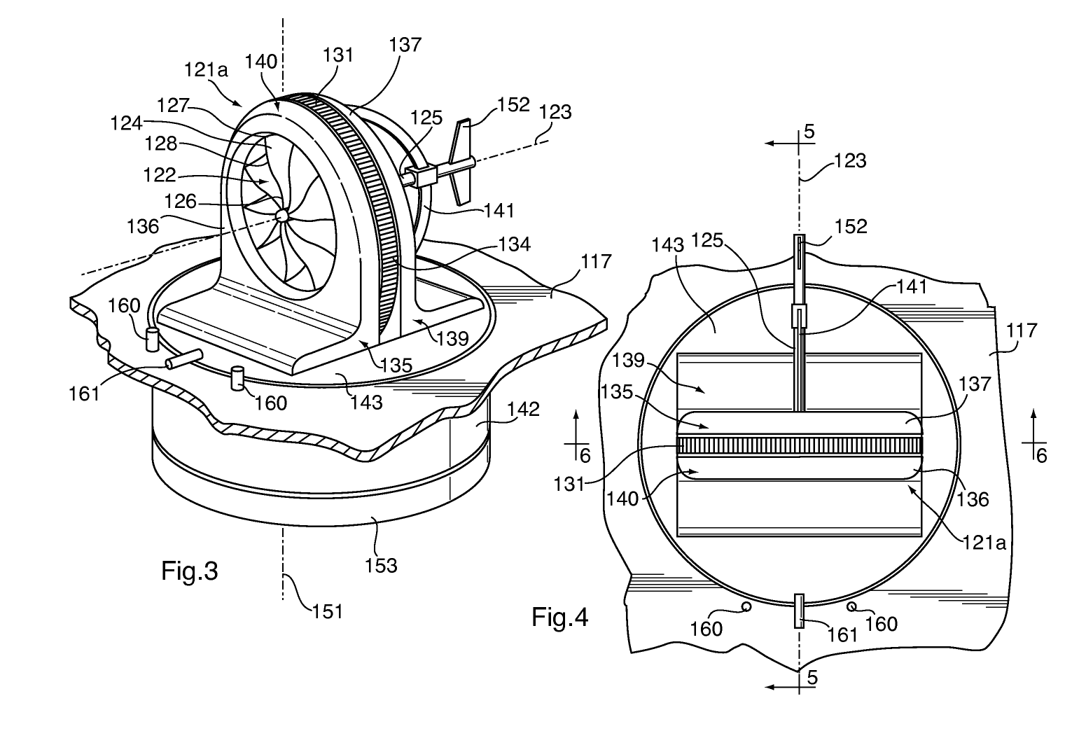

In the example shown, each blade 124 of the set of blades 122 is mounted to a central shaft 125, which extends along the blade axis 123. Each blade 124 is diagonally oriented with respect to the central shaft 125. That is, the blades 124 are at an angle θ (shown in FIG. 5) of between 0° and 90°, for example 45°, with respect to the central shaft 125. Further, each blade 124 is slightly curved. That is, each blade 124 has an inner end 126 and an outer end 127, and first 128 and second 129 opposed sides. Each blade 124 is curved between the first 128 and second 129 opposed sides.

The wind turbine 121a has a blade diameter D1 defined by a circumference of the outer ends 127 of the blades 124 when rotating about the blade axis 123.

Referring still to FIGS. 3-7, the energy recovery system 100 further comprises one or more electrical generators 130. Each electrical generator 130 is coupled to one or more of the wind turbines 121, and is configured to convert the rotational energy of the set of blades 122 of the one or more wind turbines 121 into electrical energy. Specifically, in the example shown, each set of blades 122 is coupled to a first electrical generator 130a and a second electrical generator 130b. However, in alternate examples, each set of blades 122 may be coupled to only one electrical generator, or to more than two electrical generators.

In the example shown, the wind turbine 121 comprises a gear 131 mounted around the set of blades 122 and rotatable with the set of blades 122. The electrical generators 130a, 130b are coupled to the set of blades 122 via the gear 131, and are configured to convert rotational energy of the gear 131 in to electrical energy. Specifically, in the example shown, the wind turbine 121 comprises a rotating annular bracket 132, which is mounted around the set of blades 122. The rotating annular bracket 132 comprises a central bore, in which the set of blades 122 is received. The outer end 127 of the each blade 124 is fixedly mounted to the rotating annular bracket 132, so that the rotating annular bracket 132 rotates with the set of blades 122.

In the example shown, each wind turbine 121 and electrical generator 130 combination is substantially identical. As such, the configuration of only wind turbine 121a and generators 130a and 130b connected thereto will be described in detail. In other examples there may be differences among plural wind turbines in the airflow chamber 113. For example, at least some of the wind turbines may comprise different numbers of blades. For example, wind turbines located at or toward the air inlet 118 may comprise fewer blades than turbines located toward the air outlet 119. In some examples, the plural wind turbines can include a least one front turbine having 3 blades or between 3 and 5 blades, at least one back turbine having 11 blades or between 9 and 18 blades, and at least one middle turbine having 7 blades or between 6 and about 8 blades. Reducing the number of blades on the forward mounted wind turbines relative to rearward mounted turbines may help to equalize the amount of energy harnessed by each turbine.

Referring still to FIGS. 3 to 7, the gear 131 is annular, and is fixedly mounted around the rotating annular bracket 132. Specifically, the gear 131 comprises a central bore, in which the rotating annular bracket 132 is received. The gear 131 comprises an inner surface, to which the rotating annular bracket 132 is mounted, so that the gear 131 rotates with the set of blades 122 and the rotating annular bracket 132. The gear 131 further comprises an outer surface 134, which is toothed. The toothed outer surface 134 has a pitch diameter D2. As the gear 131 is mounted around the rotating annular bracket 132 and set of blades 122, the pitch diameter D2 is greater than the blade diameter D1.

In order to reduce the weight of the system 100, and thereby increase the amount of energy transferred to the electrical generators 130, the rotating annular bracket 132 and gear 131 may be relatively thin. For example, the thickness of the gear 131 (i.e. the distance from the outer surface 134 to the inner surface) may be between about 5% and 50% of the pitch diameter D2, and more specifically, between about 10% and 20% of the pitch diameter D2.

The rotating annular bracket 132 is mounted to a fixed annular bracket 135. Specifically, the fixed annular bracket 135 comprises a front bracket portion 136, and a rear bracket portion 137, both of which are annular and define a central bore. The rotating annular bracket 132 is sandwiched between the front bracket portion 136 and the rear bracket portion 137, so that the set of blades 122 is aligned with the central bore of the front bracket portion 136 and the rear bracket portion 137, and so that the gear 131 is positioned between the front bracket portion 136 and the rear bracket portion 136. The rotating annular bracket 132 is mounted to the front 136 and rear 137 bracket portions by a plurality of bearings 138, so that the rotating annular bracket 132 and gear 131 may rotate with respect to the fixed annular bracket 135. The bearings 138 support the weight (i.e. gravity load) of the blades 122, gear 131 and rotating annular bracket 132 and absorb the thrust loads exerted on the blades 122 by the wind. The bearings 138 may be integral the rotating annular bracket 132 or may be separate elements fit within corresponding grooves or openings in the rotating annular bracket 132. In the example shown, the bearings 138 carry all of the loads placed on the blades 122 and gear 131 allowing the wind turbine 121 to be free from additional bearings or supports (for example on shaft 125). The bearings 138 may be of any suitable bearing type that make the wind turbine 121 easily rotatable by the wind, including ball bearings, needle bearings, bushings, and roller bearings.

At the bottom portion 139 of the fixed annular bracket 135, the gear 131 extends outwardly of the fixed annular bracket 135. That is, a height H1 of the top portion 140 of the fixed annular bracket 135 is less than a height H2 of a bottom portion 139 of the fixed annular bracket 135, so that the gear 131 extends proud of the bottom portion 139 of the fixed annular bracket 135.

The fixed annular bracket 135 may further comprise a rear strut 141, extending between the top portion 140 of the rear bracket portion 137 and the bottom portion 139 of the rear bracket portion 137. The rear strut 141 may provide support to the central shaft 125. More specifically, the rear strut 141 may comprise an aperture, into which the central shaft 125 extends. A plurality of bearings (not shown) may be provided in the aperture, to allow the central shaft 125 to rotate with respect to the rear strut.

The fixed annular bracket 135 is fixedly mounted to a base 142, so that the wind turbine 121 is supported by the base 142. Specifically, the fixed annular bracket 135 is mounted to the top surface 143 of the base 142, for example via bolts or screws. The base 142 is mounted to the casing 105.

In the example shown, each base 142 supports one wind turbine 121. In alternate examples, each base 142 may support more than one wind turbine 121.

In the example shown, the base 142 serves as a housing for the first and second electrical generators 130a, 130b. That is, the first 130a and second 130b generators are provided within the base 142. Specifically, the base 142 defines a cavity 144, and the first 130a and second 130b generators are housed within the cavity 144.

An aperture 145 is defined in the top surface 143 of the base 142. The portion of the annular gear 131 that extends proud of the bottom portion 139 of the fixed annular bracket 135 extends through the aperture 145, and into the cavity 144.

The first generator 130a comprises a first driveshaft 146, and a first pinion 147 is affixed to the first driveshaft 146. The first pinion 147 engages the gear 131, and more specifically, the portion of the gear 131 that extends through the aperture 145, so that the rotational energy of the gear 131 is transferred to the first pinion 147, thereby inducing rotation of the first driveshaft 146. The configuration of the gear 131 and bearings 138 may enable the gear to mesh directly with the first pinion 147, without the need for connecting shafts, linkages, gearboxes, belts or other energy transfer means.

The rotational energy of the first driveshaft 146 is converted into electrical energy in the first electrical generator 130a. The second generator 130b comprises a second driveshaft 148, and a second pinion 149 is affixed to the second driveshaft 148. The second pinion 149 engages the first pinion 147, so that a portion of rotational energy of the first pinion 147 is transferred to the second pinion 149, thereby inducing rotation of the second driveshaft 148. The rotational energy of the second driveshaft 148 is converted into electrical energy in the second electrical generator 130b.

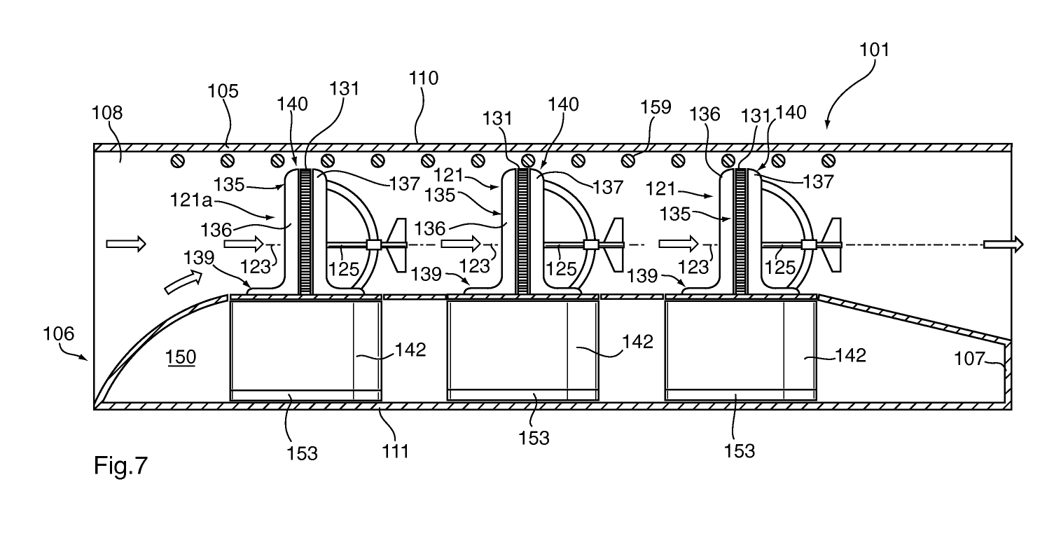

As can be seen in FIG. 7, in the example shown, the casing 105 defines a storage chamber 150, in which each base 142, and therefore each electrical generator 130, is positioned. Specifically, the lower wall 111 of the casing 105 is beneath and spaced from the bottom wall 117 of the airflow chamber 113. The storage chamber 150 is defined between the lower wall 111 and the bottom wall 117. Each wind turbine 121 is provided in the airflow chamber 113, above the bottom wall 117 of the airflow chamber 113, and each base 142 is provided below the bottom wall 117 of the airflow chamber 113, in the storage chamber 150. The bottom wall 117 of the airflow chamber 113 comprises a plurality of openings, in which the top surface 143 of the base 142 is positioned.

By providing a storage chamber 150 for the electrical generators 130 that is separate from the airflow chamber 113, air passing through the casing 105 is generally forced to engage the set of blades 122, and may not bypass the set of blades 122 by flowing around the electrical generators 130. Optionally, everything between the upper and lower walls 110, 111, including the storage chamber 150 and electrical generators 130, may be configured as a single cartridge, as described above.

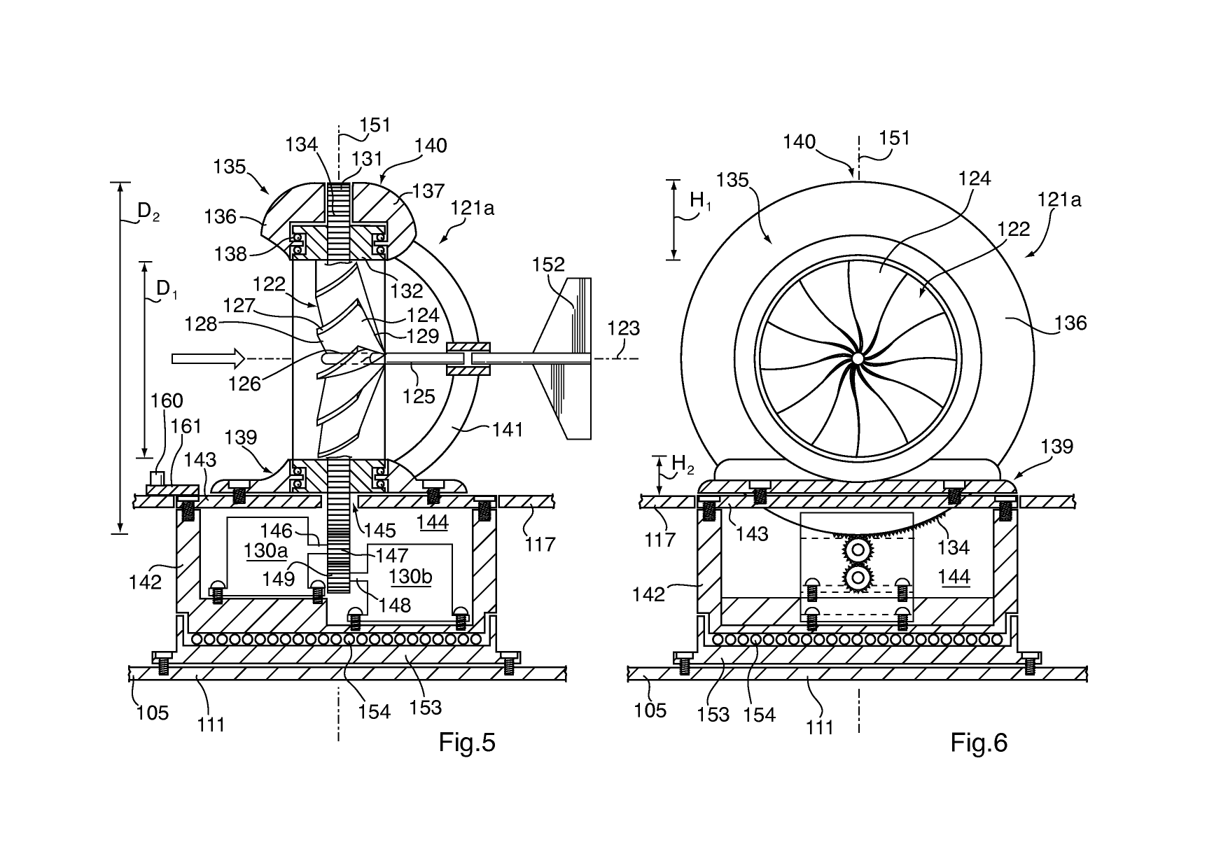

Referring back to FIGS. 5 and 6, the base 142 is rotatably mounted to the lower wall 111 of the casing 105. Specifically, the base 142 is rotatable with respect to the casing 105, the airflow chamber 113, and vehicle 100, about a base axis 151 (also referred to herein as a housing axis), which extends transverse to the blade axis 123. For example, the base axis 151 may be perpendicular to the blade axis 123. In the example shown, the base axis 151 is vertical. However, in alternate examples, the base axis 151 may be at another angle, for example 10° off of vertical.

As the wind turbine 121 is mounted to and supported by the base 142, the wind turbine 121 is rotatable with the base 142 about the base axis 151. Further as the base 142 serves as a housing for the generators 130a, 130b, the generators 130a, 130b are also rotatable with the base 142 about the base axis 151.

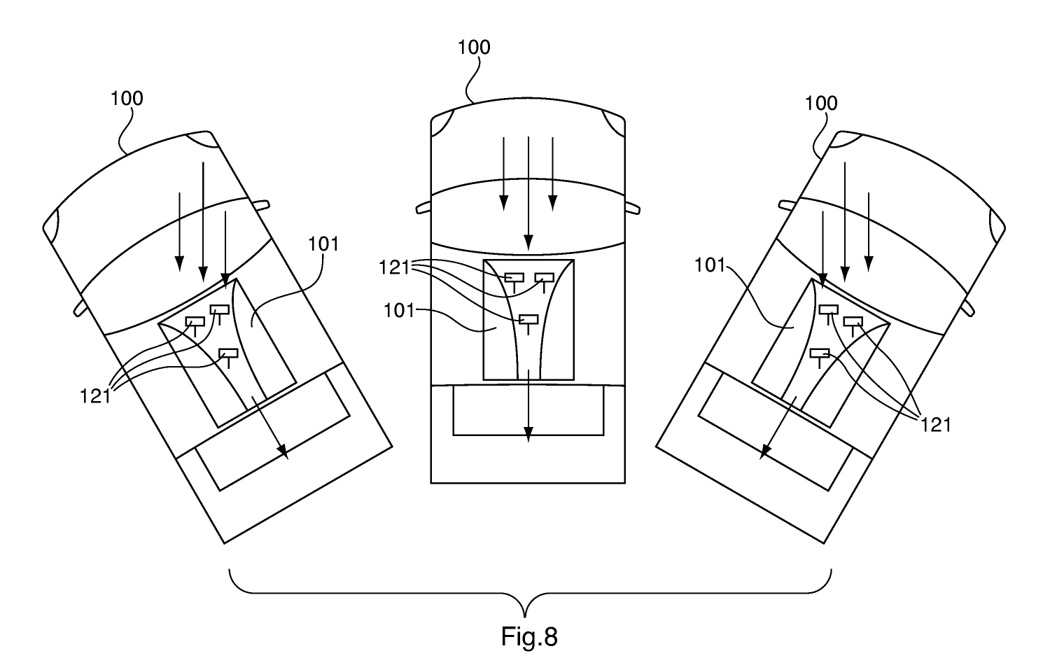

Referring to FIG. 8, by rotatably mounting the base 142 to the lower wall 111 so that the wind turbines 121 are rotatable, the wind turbines 121 may rotate about the base 142 axis in response to any changes in wind direction. That is, the wind turbines 121 will rotate so that the blade axis 123 is parallel to the wind direction passing through the airflow chamber 113. The change in wind direction may be due to a shift in the ambient wind conditions, or as a result or changing the orientation of the vehicle 100 relative to the wind. This allows the set of blades 122 to maximize the amount of kinetic energy that is transferred from the wind to the set of blades 122.

In the example shown, the energy recovery system 100 further comprises a wind vane 152. The wind vane 152 is mounted to the wind turbine 121, and more specifically, to the strut 141. In alternate examples, the wind vane 152 may be mounted to the base 142, or to both the base 142 and the wind turbine 121. The wind vane 152 aids in allowing the wind turbine 121 to rotate so that the blade axis 123 is parallel to the wind direction passing through the airflow chamber 113.

The base 142 may be rotatably mounted to the lower wall 111 in any suitable fashion. In the example shown, a mounting plate 153 is provided between the lower wall and the bottom wall of the base 142. The mounting plate 153 is fixedly mounted to the lower wall 111, and the base 142 is rotatably mounted to the mounting plate 153. More specifically, a plurality of bearings 154 are provided between the base 142 and the mounting plate 153.

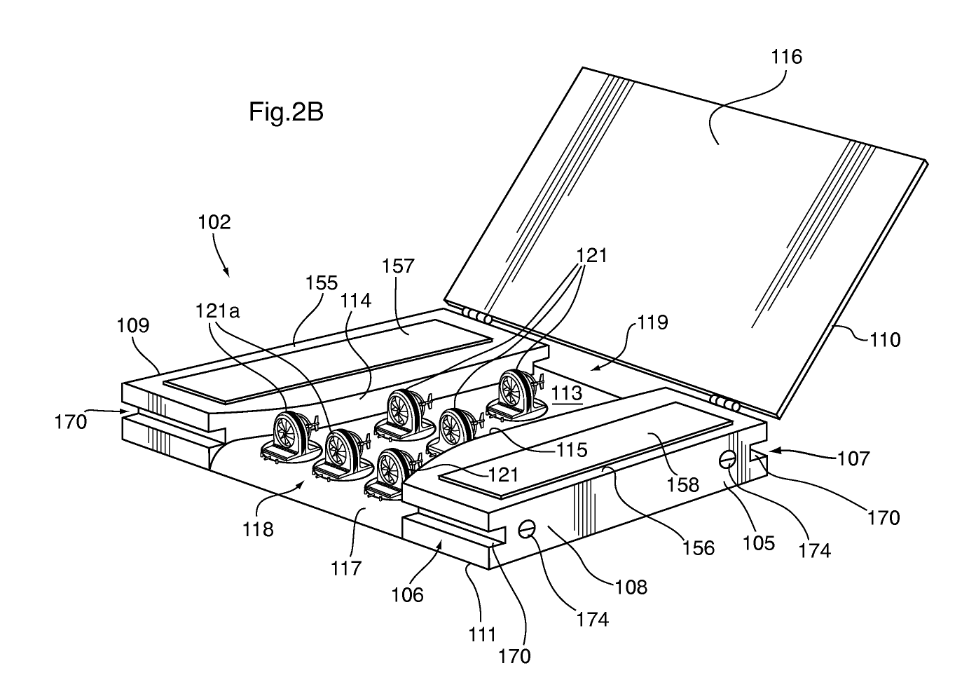

In some examples, as shown in FIGS. 3 and 4, the energy recovery system 102 may further comprise one or more stops limiting the rotation of the base 142. This may be useful to prevent the wind turbines from spinning about the base axis 151. For example, the bottom wall 117 may comprise two fixed pins 160 extending upwardly therefrom, and positioned 35° apart from each other. The top surface 143 of the base 142 may comprise a base pin 161 extending outwardly therefrom and fixedly mounted thereto, and positioned between the plate pins 160. As the base 142 rotates, the base pin 161 will rotate, and will contact the fixed pins 160. The fixed pins 160 will prevent any rotation of the base 142 greater than 35°.

Referring back to FIG. 2, the energy recovery system 100 further comprises at least one battery coupled to the electrical generators 130. In the example shown, the casing 105 defines a first 155 and a second 156 battery storage compartment on opposed sides of the airflow chamber 113. A first battery 157 is provided in the first battery storage compartment 155, and a second battery 158 is provided in the second battery storage compartment 156. The batteries 157, 158 may be coupled to the electrical generators 130 in any suitable fashion.

In the example shown, the batteries 157, 158 are non-rotatably mounted with respect to the vehicle 100. Accordingly, the electrical generators 130 rotate with respect to the batteries 157, 158. As such, a coupling which can accommodate the rotation of the generators 130 with respect to the batteries 157, 158 may be used to couple the electrical generators 130 to the batteries (not shown).

The batteries 157, 158 may be used to power various systems in the vehicle 100. For example, if the vehicle 100 is an electric automobile, the batteries 157, 158 may power the motor of the automobile. Alternately, the battery may power any of the starter motor, the lights, or the ignition system of the vehicle 100. Alternately, some or all of the energy stored in the batteries 157, 158 may be fed to an external electrical grid.

The energy recovery system 102 may further comprise a heating system, for example to prevent icing of the set of blades 122 during winter conditions. For example, as shown in FIG. 7, one or more heating elements 159 may be provided in the casing 105. The heating system may be powered by the batteries 157, 158.

In use, the energy recovery system 102 may be mounted to the vehicle 100, for example by securing the casing 105 to the roof 103. The casing 105 may be mounted so that the inlet 118 of the airflow chamber 113 faces the front of the vehicle 100, and the outlet 119 of the airflow chamber 113 faces the rear of the vehicle 100. The vehicle 100 may then be driven. As the vehicle 100 moves forward, wind will pass through the airflow chamber 113, and the kinetic energy of the wind will be converted to rotational energy of the sets of blades 122 of the wind turbines 121. The rotation of the sets of blades 122 will be transferred to the gears 131 via the rotating annular brackets 132, and the rotation of the gears 131 will be transferred to the first 147 and second 149 pinions of the generators 130. The generators 130 will convert the rotational energy of the first 147 and second 149 pinions into electrical energy, and the electrical energy will be stored in the batteries 157, 158. If the direction of wind through the airflow chamber 113 changes, for example when the vehicle 100 is turning, the wind turbines 121, which are mounted to the bases 142, which are in turn rotatably mounted to the casing 105, will rotate to face the direction of the wind.

In addition, the energy recovery systems 101, 102 may generate energy when the vehicle 100 is parked. For example, any ambient wind in the environment surrounding the car may pass through the airflow chamber 113, and cause the sets of blades 122 to rotate. In addition to extracting wind energy, the energy recovery systems 101, 102 may include additional energy generating devices, including solar panels.

While the above description provides examples of one or more processes or apparatuses, it will be appreciated that other processes or apparatuses may be within the scope of the accompanying claims.

1. An energy recovery system for a vehicle comprising:
a) an electrical generator provided within a housing, the housing rotatable relative to the vehicle about a housing axis; and
b) a wind turbine comprising a set of blades rotatable about a blade axis extending transverse to the housing axis, the wind turbine supported by the housing and rotatable with the housing;
wherein the electrical generator is coupled to the wind turbine and configured to convert the rotational energy of the set of blades into electrical energy.

2. The energy recovery system of claim 1, further comprising a wind vane mounted to at least one of the wind turbine and the housing.

3. The energy recovery system of claim 2, further comprising one or more stops limiting the rotation of the housing.

4. The energy recovery system of claim 2, wherein the housing axis is generally vertical, and the blade axis is generally horizontal.

5. The energy recovery system of claim 4, further comprising a second electrical generator provided within the housing and coupled to the wind turbine and configured to convert the rotational energy of the set of blades into electrical energy.

6. The energy recovery system of claim 1, wherein the wind turbine further comprises a gear mounted around the set of blades and rotatable with the set of blades, and the electrical generator is coupled to the set of blades via the gear.

7. The energy recovery system of claim 6, further comprising at least one battery electrically coupled to the electrical generator.

8. The energy recovery system of claim 7, wherein the battery is non-rotatably mounted with respect to the vehicle.

9. The energy recovery system of claim 1, wherein:
a) the energy recovery system further comprises an airflow chamber mountable to the exterior of the vehicle, the airflow chamber comprising an air inlet positionable to receive an incoming stream of air, and an air outlet positionable to exhaust the stream of air; and
b) the wind turbine is provided within the airflow chamber.

10. The energy recovery system of claim 9, wherein the airflow chamber has an inlet cross sectional area at the inlet, and a reduced cross-sectional area at a position downstream of the inlet.

11. The energy recovery system of claim 10, wherein the airflow chamber is defined by a casing, which is removably mounted to the vehicle.

12. The energy recovery system of claim 11, wherein the casing further defines a storage chamber in which the housing is received.

13. The energy recovery system of claim 12, wherein the airflow chamber has a bottom wall, the casing has a lower wall beneath and spaced from the bottom wall, and the storage chamber is between the bottom wall and the lower wall.

14. The energy recovery system of claim 13, wherein the housing is mounted to the lower wall.

15. The energy recovery system of claim 13, wherein the bottom wall extends upwardly from the air inlet towards the air outlet.

16. An energy recovery system for a vehicle comprising:
a) an airflow chamber mountable to an exterior of the vehicle, the airflow chamber comprising an air inlet positionable to receive an incoming stream of air, and an air outlet positionable to exhaust the stream of air, the airflow chamber having an inlet cross sectional area at the inlet, and a reduced cross-sectional area at a position downstream of the inlet;
b) one or more wind turbines provided in the airflow chamber, each wind turbine comprising a set of blades rotatable about a blade axis;
c) one or more bases, each base supporting one or more of the wind turbines, each base rotatable with respect to the airflow chamber about a base axis extending transverse to the blade axis;
d) one or more electrical generators, each electrical generator coupled to one or more of the wind turbines and configured to convert the rotational energy of the set of blades of the one or more wind turbines into electrical energy.

17. The energy recovery system of claim 16, wherein each base serves as a housing for one or more of the electrical generators, the one or more of the electrical generators rotatable with the base.

18. The energy recovery system of claim 17 wherein the airflow chamber is defined by a casing, and wherein the casing further defines a storage chamber in which the electrical generators are received.

19. The energy recovery system of claim 18, wherein the airflow chamber has a bottom wall, the casing has a lower wall beneath and spaced from the bottom wall, and the storage chamber is between the bottom wall and the lower wall.

20. An energy recovery system for a vehicle comprising:
a) a casing mountable to an exterior of the vehicle, the casing defining a storage chamber and an airflow chamber, the airflow chamber comprising an air inlet positionable to receive an incoming stream of air, an air outlet positionable to exhaust the stream of air, and an axis extending therebetween;
b) one or more wind turbines in the airflow chamber, each wind turbine comprising a set of blades rotatable about a blade axis;
c) one or more electrical generators in the storage chamber, each electrical generator coupled to one or more of the wind turbines and configured to convert the rotational energy of the set of blades into electrical energy; and
d) a wall separating the storage chamber from the airflow chamber, at least a portion of the wall extends towards the axis so that a cross-sectional area of the airflow chamber at a position downstream of the inlet is less than an cross-sectional area of the airflow chamber at the inlet.
